(19) United States
(12) Patent Application Publication
(10) Pub. No.: US 2015/0040386 A1
(43) Pub. Date: Feb. 12, 2015

(54) MOUNTING APPARATUS

(71) Applicants: HONG FU JIN PRECISION INDUSTRY (Wuhan) CO., LTD., Wuhan (CN); HON HAI PRECISION INDUSTRY CO., LTD., New Taipei (TW)

(72) Inventors: GUI-CHU ZHOU, Wuhan (CN); YI-LUN GAN, Wuhan (CN); WEN-HUAN LIU, Wuhan (CN)

(21) Appl. No.: 14/455,177

(22) Filed: Aug. 8, 2014

(30) Foreign Application Priority Data
Aug. 9, 2013 (CN) 201310345669X

(51) Int. Cl. B23P 19/04; B23P 19/00

(52) U.S. Cl. CPC B23P 19/04; B23P 19/001
USPC 29/822

(57) ABSTRACT

A mounting apparatus for securing a component in a cushion to a device and includes a receiving module, a fetching module, a control module, a positioning module, and a mounting module. The fetching module is moveable to catch the cushion. The positioning module includes a stage and a pair of positioning members. The pair of positioning members is moveable between a locked position in which the pair of positioning members is deviated from the stage. The cushion being located between the pair of positioning members and the stage and an unlock position in which the pair of positioning members is located on the stage to position the cushion. The mounting module secures the cushion on the stage to the device.

### FIELD

The present disclosure relates to mounting apparatus, and particularly to a mounting apparatus for securing components to a device.

### BACKGROUND

A device such as a storage device or a fan may require components, such as rubbers or gaskets, to be secured to the device one by one. The rubbers or the gaskets can be used to absorb vibrations from the device.

### BRIEF DESCRIPTION OF THE DRAWINGS

Implementations of the present technology will now be described, by way of example only, with reference to the attached figures, wherein:

FIG. 1 is a block diagram of a mounting apparatus.

FIG. 2 is a cutaway view of the mounting apparatus of FIG. 1, and a fetching member is aligned with a receiving module.

FIG. 3 is an enlarged view of a circled portion III of FIG. 2, and a pair of positioning members is located on a locked position.

FIG. 4 is a front view of the mounting apparatus of the mounting apparatus of FIG. 2.

FIG. 5 is similar to FIG. 2, but a pair of positioning members is located on a unlock position.

FIG. 6 is an enlarged view of a circled portion VI of the mounting apparatus of FIG. 2.

FIG. 7 is similar to FIG. 2, and a cushion is positioned by the pair of positioning members.

FIG. 8 is an enlarged view of a circled portion VIII of the mounting apparatus of FIG. 7.

FIG. 9 is similar to FIG. 2, and a mounting member is aligned with a stage.

FIG. 10 is an enlarged view of a circled portion X of the mounting apparatus of FIG. 7.

FIG. 11 is a side view of the mounting apparatus of FIG. 9.

FIG. 12 is similar to FIG. 2, and a discarding member is aligned with a stage.

FIG. 13 is an enlarged view of a circled portion XIII of the mounting apparatus of FIG. 12.

FIG. 14 is similar to FIG. 12, but viewed from a different angle.

FIG. 15 is an enlarged view of a circled portion XV of the mounting apparatus of FIG. 14.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections.

The connection can be such that the objects are permanently connected or releasably connected. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a mounting apparatus for securing a component in a cushion to a device. The mounting apparatus comprises a receiving module configured for receiving the cushion, a fetching module, and a control module. Thee fetching module is moveable by the control module to catch the cushion from the receiving module. A positioning module comprises a stage and a pair of positioning members. The pair of positioning members is moveable by the control module between a locked position in which the pair of positioning members is deviated from the stage and configured for the cushion being located between the pair of positioning members and the stage and an unlock position in which the pair of positioning members located on the stage to position the cushion. A mounting module is moveable by the control module to secure the cushion on the stage to the device.

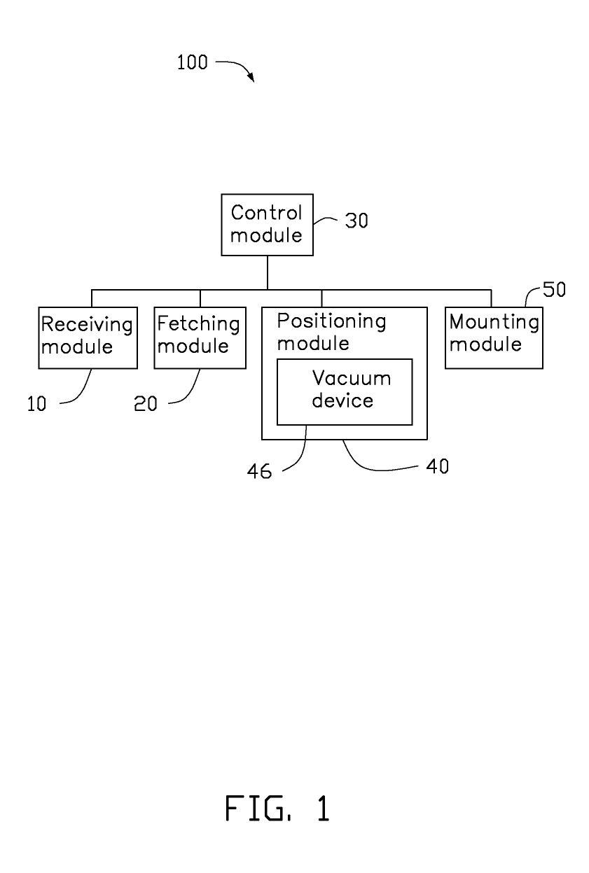

FIGS. 1-3 illustrate an embodiment of a mounting apparatus. The mounting apparatus comprises a receiving module 10, a fetching module 20, a control module 30, a positioning module 40, a mounting module 50, and a platform 71. The receiving module 10, the fetching module 20, the control module 30, the positioning module 40, and the mounting module 50 are secured to the platform 71. A plurality of cushions 61, each securing a plurality of components 62, is received in the receiving module 10. The mounting apparatus can mount the plurality of components 62 to a device 63. In at least one embodiment, each of the plurality of components 62 can be a rubber gasket.

The control module 30 is used to move the receiving module 10 towards the fetching module 20. The fetching module 20 is used to fetch one of the cushions 61 to the positioning module 40. The positioning module 40 is used to position the one of the cushions 61 retrieved by the fetching module 40 to a suitable location. The mounting module 50 is used to mount the plurality of components 62 on one of the cushions 61 positioned by the positioning module 40 to the device 63. In at least one embodiment, the control module 30, comprising a Programmable Logic Controller (PLC) controls the fetching module 20, the positioning module 40, and the mounting module 50.

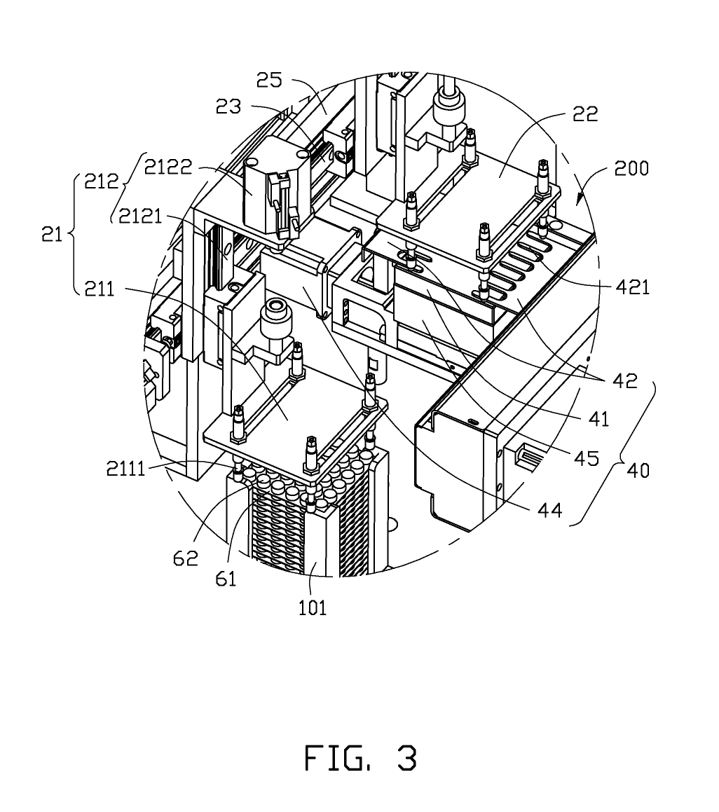

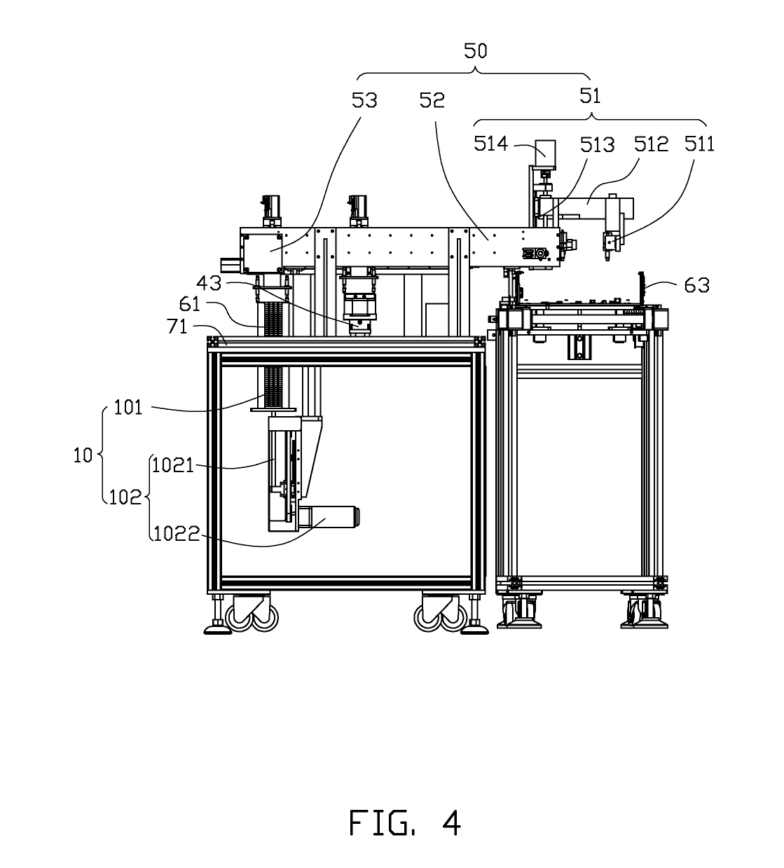

FIGS. 3-4 illustrate an embodiment of the receiving module 10. The receiving module 10 comprises a receiving shelf 101 and a pushing member 102. The plurality of cushions 61 is stacked in the receiving shelf 101. The pushing member 102 comprises a pushing pole 1021 and a motor 1022 coupled to the pushing pole 1021. The pushing pole 1021 extends through the receiving shelf 101 and is adhered to a bottom of one of the cushions 61, so that the pushing pole 1021, which is controlled by the motor 1022, can move the plurality of cushions 61 upward or downward.

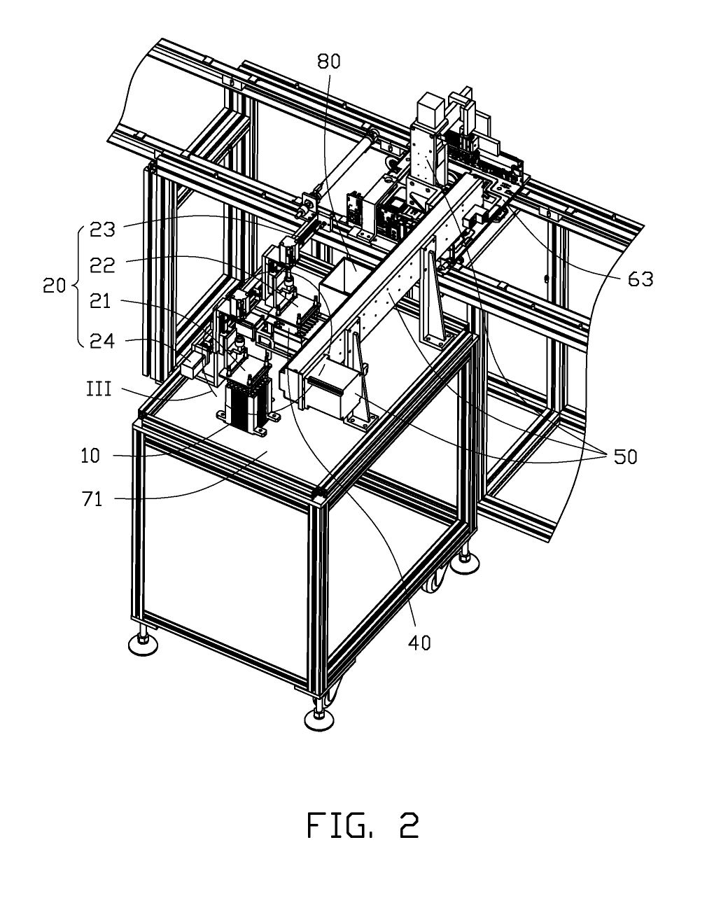

FIGS. 2-3 illustrate an embodiment of the fetching module 20. The fetching module 20 comprises a fetching member 21, a discarding member 22, a first guiding rail 23, a first driving member 24, and a connecting member 25. The fetching member 21 is used to catch the plurality of cushions 61 on the receiving shelf 101 to the positioning module 40 and can comprise a fetching portion 211 and a driving portion 212. The fetching portion 211 comprises four suctioning devices 2111 for suctioning the plurality of cushions 61. The driving portion 2122 comprises a guiding rail 2121 and a driving motor 2122 coupled to the guiding rail 2121. The guiding rail 2121 is substantially perpendicular to the platform 71 and can be moved upward or downward by the driving motor 2122, which is controlled by the control module 30. The connecting member 25 is coupled to the fetching member 21 and the discarding member 22. In at least one embodiment, the discarding member 22 can have a same configuration as the fetching member 21.

The first guiding rail 23 is substantially parallel to the platform 71. The fetching member 21 and the discarding member 22 can be slidably attached to the first guiding rail 23. The first driving member 24 is coupled to the fetching member 21 and can move the fetching member 21 along the first guiding rail 23 in a first direction substantially parallel to the platform 71, so that the discarding member 22 also can move in the first direction. In at least one embodiment, the first driving member 24 is a motor and is also controlled by the control module 30.

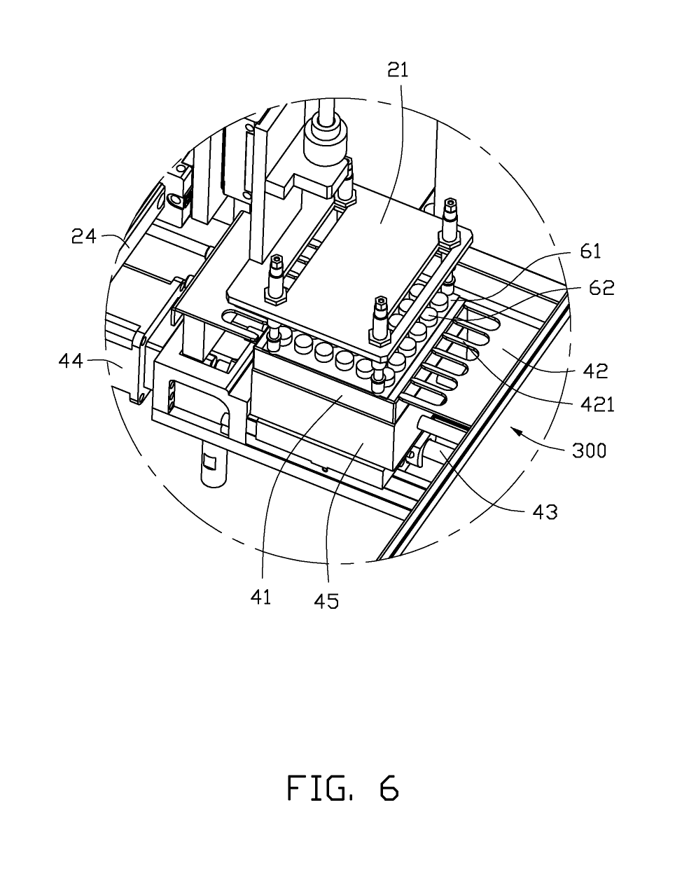

FIGS. 3 and 6 illustrate an embodiment of the positioning module 40. The positioning module 40 can comprises a stage 41, a pair of positioning members 42, a second guiding rail 43, a second driving member 44, and a positioning motor 45. The pair of positioning members 42 is located on opposite sides of the stage 41, and each positioning member 42 comprises a plurality of teeth 421. A distance between every two adjacent teeth 421 is substantially equal to a distance between every two adjacent components 62. The positioning motor 45 is located below the stage 41 and coupled to the pair of positioning members 42. The control module 30 controls the positioning motor 45 to move the pair of positioning members 42 along a direction away from each other or along a direction toward to each other.

The second guiding rail 43 is substantially parallel to the platform 71 and perpendicular to the first guiding rail 23. The stage 41 and the positioning motor 45 are slidably attached to the second guiding rail 43. A distance between the second guiding rail 43 and the receiving shelf 101 is substantially equal to a length of the connecting member 25. The second driving member 44 is coupled to the positioning motor 45 and is controlled by the control module 30 to start the positioning motor 45, so that the stage 41 can move along the second guiding rail 43. In at least one embodiment, the second driving member 44 is a motor and is controlled by the control module 30.

The positioning module 40 further comprises a vacuum device 46. When one of the cushions 61 is placed on the stage 41, the vacuum device 46 draws air between the cushion 61 and the stage 41 to prevent the cushion 61 from warping.

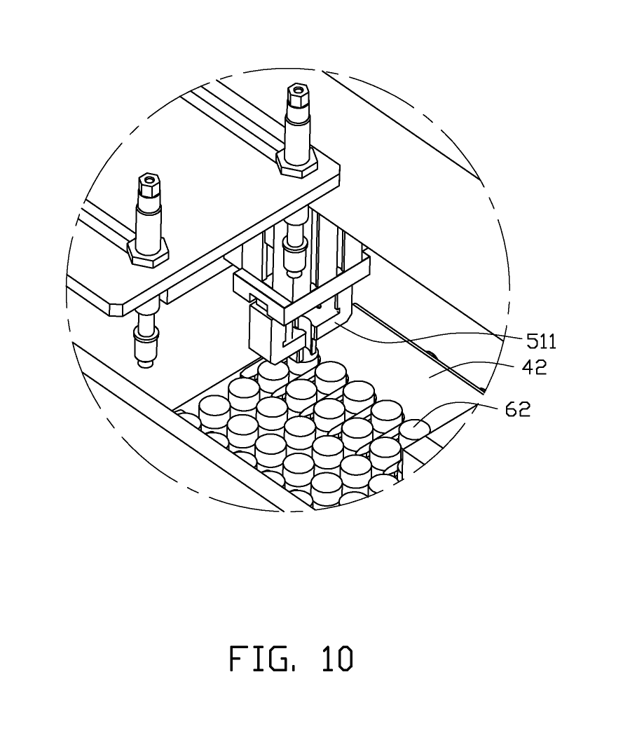

FIGS. 2-4 and 10 illustrate an embodiment of the mounting module 50. The mounting module 50 comprises a mounting member 51, a third guiding rail 52, and a third driving member 53. The mounting member 51 is used to mount the plurality of components 62 to the device 63 and comprises a mounting clamp 511, a connecting portion 512, an up-down guiding rail 513, and an up-down motor 514. A first end of the connecting portion 512 is coupled to the mounting clamp 511, and a second end of the connecting portion 512 is slidably attached to the up-down guiding rail 513. The up-down guiding rail 513 is substantially perpendicular to the platform 71. The up-down motor 514 is coupled to the connecting portion 512, so that the up-down motor 514 can move the connecting portion 512 upward or downward. When the connecting portion 512 is moved upward or downward, the mounting clamp 511 can be moved upward or downward together with the connecting portion 512. The third guiding rail 52 is substantially parallel to the first guiding rail 23, and the mounting member 51 is slidably attached to the third guiding rail 52. The third driving member 53 can move the mounting member 51 along the third guiding rail 52 in the first direction substantially parallel to the platform 71. In at least one embodiment, the third driving member 53 is a motor and is controlled by the control module 30.

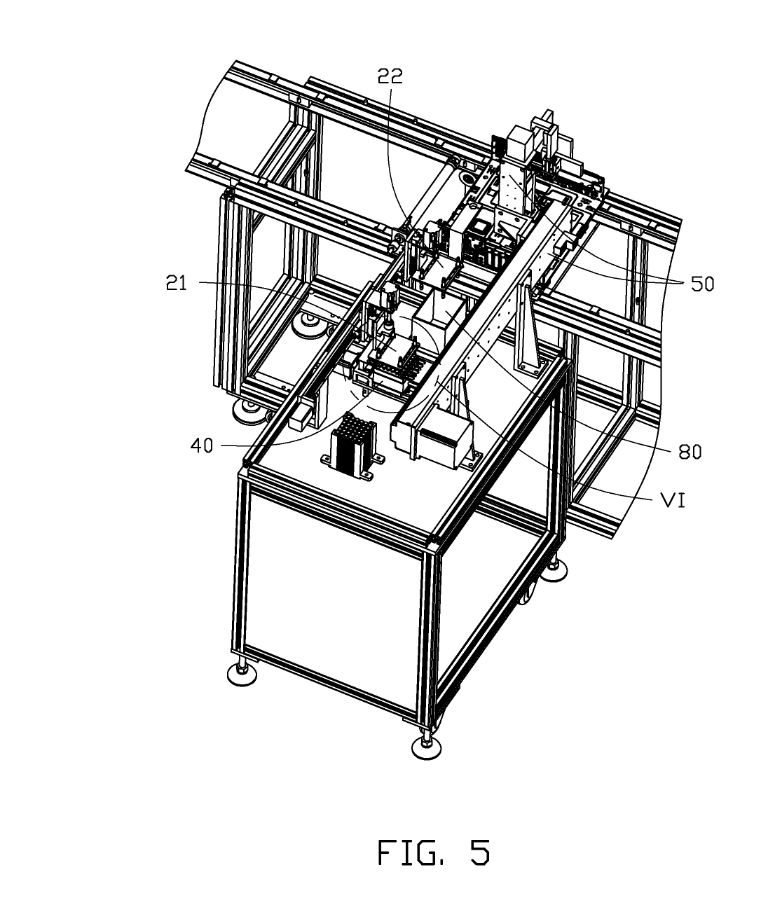

FIG. 5 illustrates an embodiment of the mounting apparatus. The mounting apparatus further comprises a storage member 80 for storing a cushion 61, which is moved from the stage 41. The storage member 80 is secured to the platform 71. In one embodiment, the storage member 80 is a box.

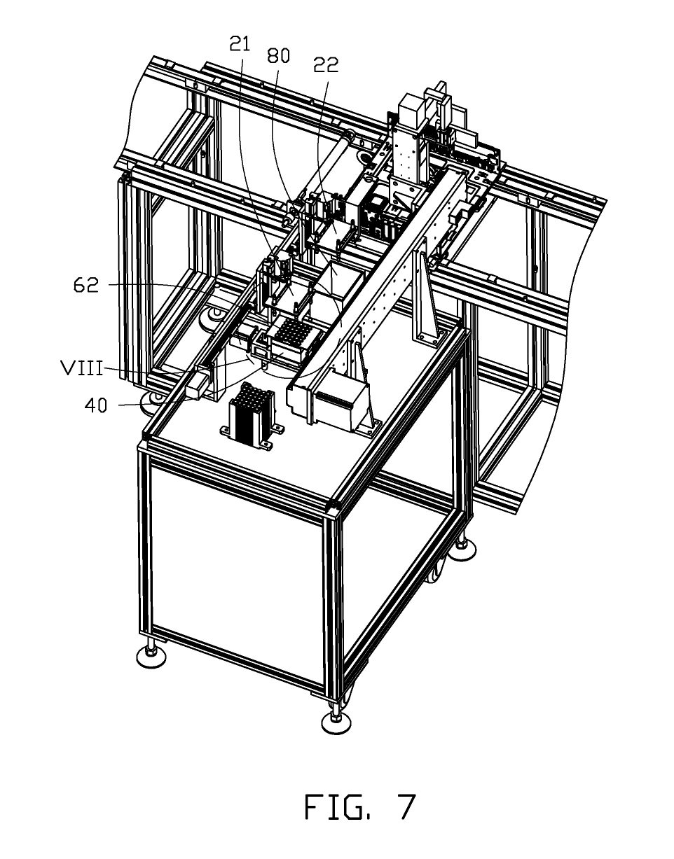

FIGS. 2-8 illustrate that mounting apparatus fetches the plurality of cushions 61. The second driving member 44 moves the stage 41 and the positioning motor 45 along the second guiding rail 43 until the stage 41 reaches a first end of the second guiding rail 43, which is adjacent to the first guiding rail 23. At this time, the pair of positioning members 42 is located in a locked position (see FIG. 3), the plurality of teeth 421 extend through the stage 41 and are positioned above the stage 41. A first vertical distance, less than a thickness of each cushion 61, is defined between the stage 41 and each positioning member 42, preventing the top one of the cushions 61 from stretching between the stage 41 and the pair of the positioning members 42.

The first driving member 24 moves the fetching member 21 along the first guiding rail 23 , until the fetching member 21 is located above the receiving shelf 101. The discarding member 22 is moved along with the fetching member 21 and is positioned above the receiving shelf 101. The pushing member 102 pushes the plurality of cushions 61 upward, until the top one of the cushions 61 reaches the top portion of the receiving shelf 101. The driving motor 2122 moves the fetching portion 211 downward along the guiding rail 2121, so that the fetching portion 211 can fetch the top one of the cushions 61 out of the receiving shelf 101. Then, the driving motor 2122 moves the fetching portion 211 along the guiding rail 2121 upward and away from the receiving shelf 101.

The first driving member 24 moves the fetching member 21 along the first guiding rail 23 until the fetching member 21 clasps the top one of the cushions 61 located above the stage 41. The discarding member 22 is moved together with the fetching member 21 and is positioned above the storage member 80.

The positioning motor 45 moves the pair of positioning members 42 along a direction away from each other to be positioned in an unlock position (see FIG. 6). In the unlock position, the pair of positioning members 42 is away from the stage 41 and located on opposite sides of the stage 41. The teeth 421 of the pair of positioning members 42 are removed from the stage 41. A second vertical distance, greater than a thickness of each cushion 61, is defined between the stage 41 and each positioning member 42, allowing the top one of plurality of cushions 61 to stretch between the stage 41 and the pair of the positioning members 42.

The driving motor 2122 moves the fetching portion 211 downward and along the guiding rail 2121 to place the top one cushion 61 onto the stage 41. When the top one cushion 61 is positioned on the stage 41, the driving motor 2122 moves the fetching portion 211 upward and along the guiding rail 2121.

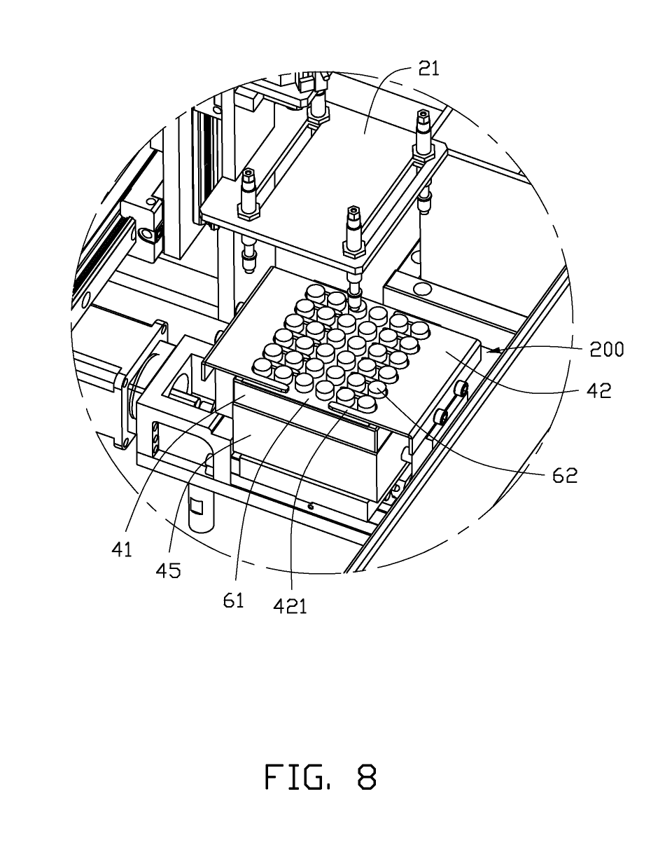

The positioning motor 45 moves the pair of positioning members 42 along a direction close to each other to be located in the locked position (see FIG. 8). Thus, each of the pair of positioning members 42 can stretch into a gap between every two adjacent components 62. Because the first vertical distance is less than the thickness of the cushion 61, the cushion 61 can be stably sandwiched between the stage 41 and the pair of positioning members 42.

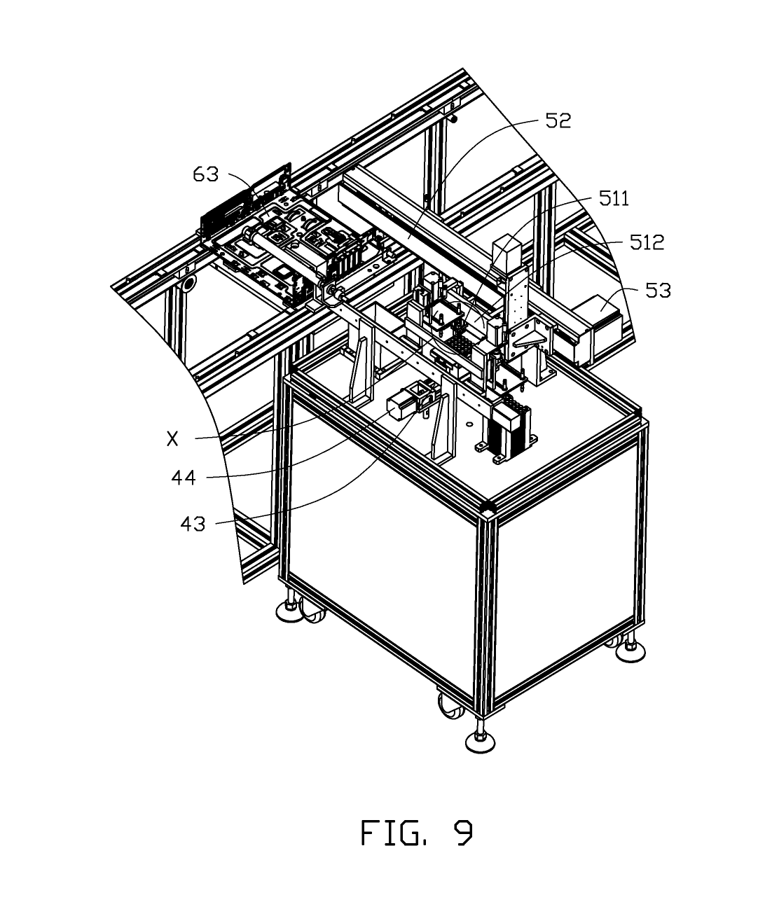

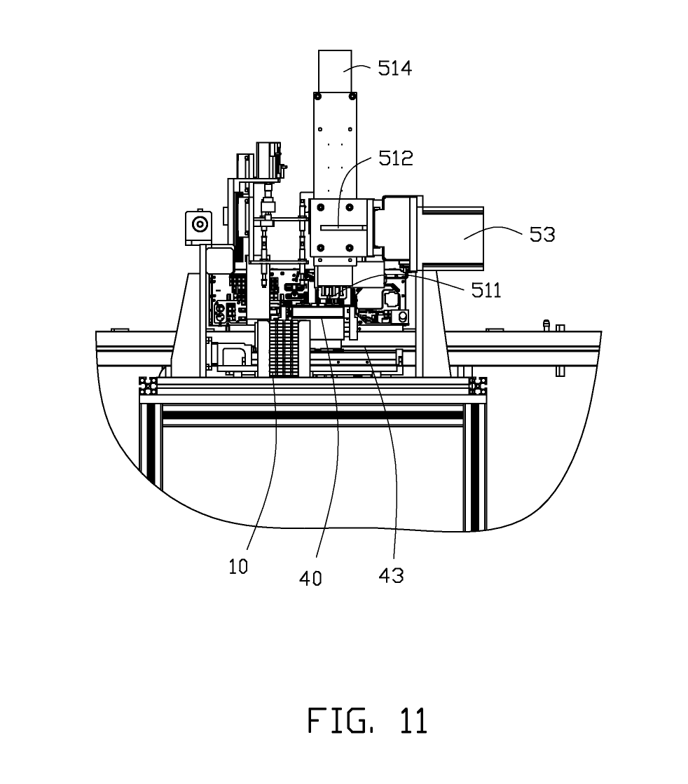

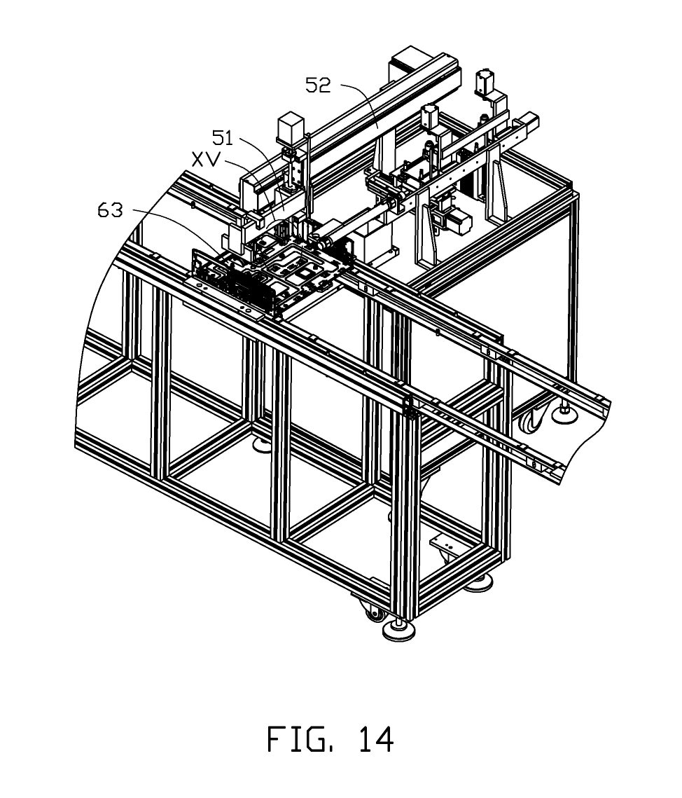

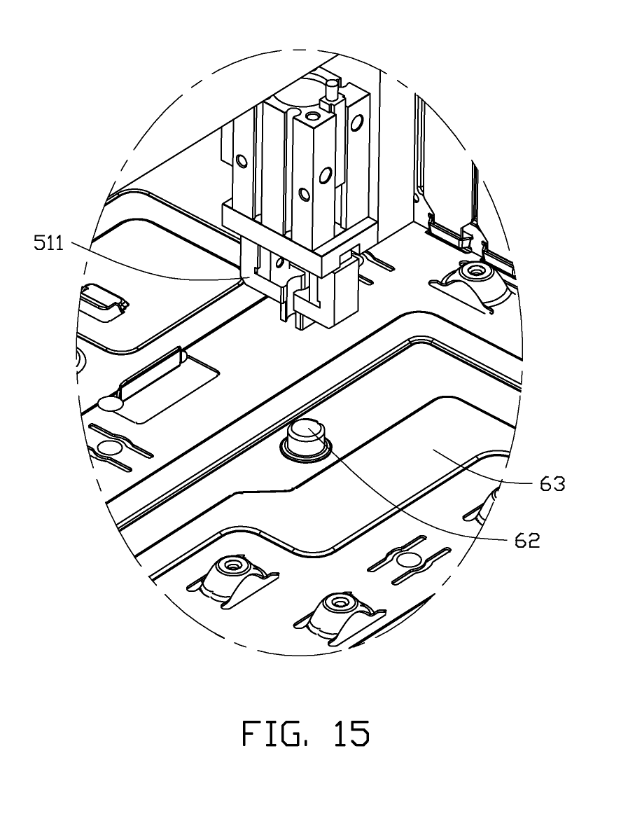

FIGS. 9-11 and 14-15 illustrate that when the mounting apparatus is mounting the component 62 of the top one of the cushions 61 to the device 63. The third driving member 53 moves the mounting member 51 along the third guiding rail 52, the second driving member 44 moves the stage 41 and the positioning motor 45 along the second guiding rail 43, until the mounting clamp 511 is aligned with a component 62. The up-down motor 514 moves the connecting portion 512 downward along the up-down guiding rail 513, so that the mounting clamp 511 can move downward and clamp the cushion 61. Then, the up-down motor 514 moves the connecting portion 512 upward, so that the mounting clamp 511 can move upward away from the cushion 61.

The third driving member 53 moves the mounting member 51 along the third guiding rail 52 until the mounting clamp 511 is aligned with the device 63. The up-down motor 514 moves the connecting portion 512 downward along the up-down guiding rail 513, so that the mounting clamp 511 can mount the component 62 to the device 63.

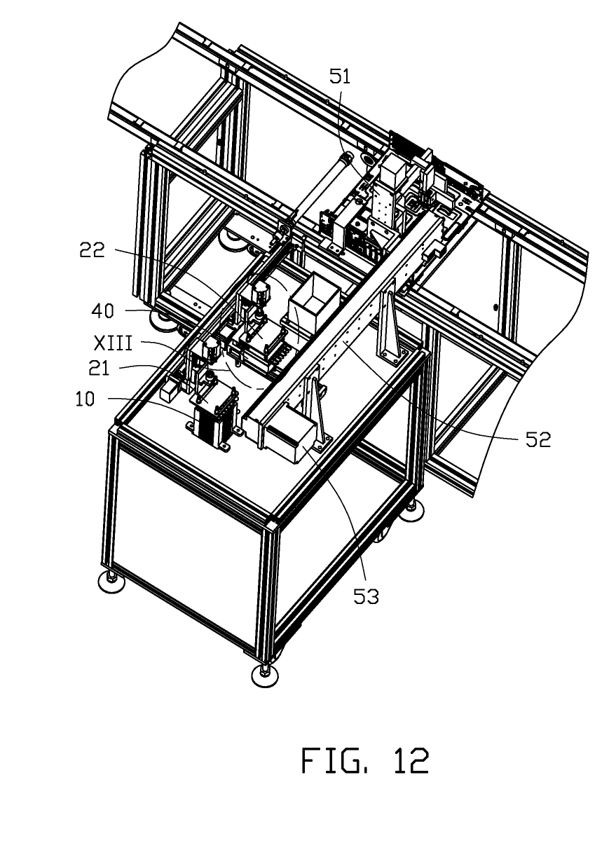

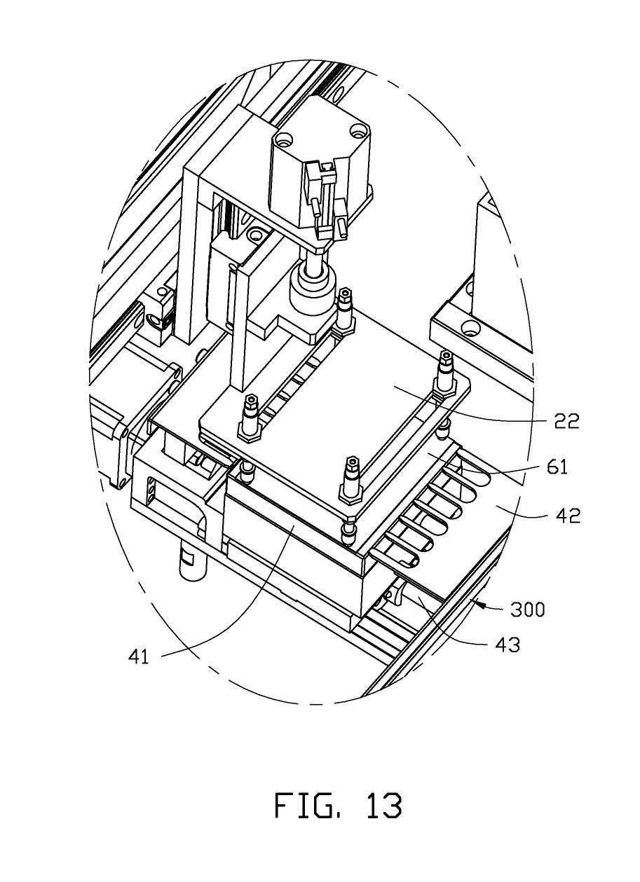

FIGS. 3, 7 and 12-13 illustrate that the cushion 61 is removed from the stage 41. The second driving member 44 moves the stage 41 and the positioning motor 45 along the second guiding rail 43 until the stage 41 reaches a second end of the second guiding rail 43 adjacent to the first guiding rail 23. The first driving member 24 moves the fetching member 21 along the first guiding rail 23 until the fetching member 21 is located above the receiving shelf 101. The discarding member 22 is moved together with the fetching member 21 and is positioned on the stage 41. The positioning motor 45 moves the pair of positioning members 42 to be positioned in the unlock position (see FIG. 13), and the discarding member 22 absorbs the cushion 61 that has no component 62. Simultaneously, the fetching member 21 catches a next one of the cushions 61.

The first driving member 24 moves the fetching member 21 along the first guiding rail 23 until the fetching member 21 is located above the stage 41. The discarding member 22 is moved together with the fetching member 21 to position above the storage member 80 placing the cushion 61 with no component 62 into the storage member 80. Simultaneously, the fetching member 21 places the next one of the cushions 61 onto the stage 41 for mounting.

The embodiments shown and described above are only examples. Many details are often found in the art such as the other features of a receiving module or a fetching module. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A mounting apparatus configured for securing a component in a cushion to a device, the mounting apparatus comprising:
a receiving module configured for receiving the cushion;
a fetching module;
a control module; the fetching module is moveable by the control module to catch the cushion from the receiving module;
a positioning module comprising a stage and a pair of positioning members; the pair of positioning members is moveable by the control module between: (i) a locked position in which the pair of positioning members is deviated from the stage and configured for the cushion being located between the pair of positioning members and the stage, and (ii) an unlock position in which the pair of positioning members located on the stage to position the cushion; and
a mounting module being moveable by the control module to secure the cushion on the stage to the device.

2. The mounting apparatus of claim 1, wherein when the pair of positioning members is located on the locked position, a first vertical distance, less than a thickness of the cushion, is defined between the stage and each positioning member, for preventing the cushions from stretching between the stage and the pair of the positioning members; when the pair of positioning members is located on the unlock position, a second vertical distance, greater than the thickness of the cushion, is defined between the stage and each positioning member, for allowing the cushions from stretching between the stage and the pair of the positioning members.

3. The mounting apparatus of claim 1, wherein a plurality of teeth is located on each of the pair of positioning members, when the pair of positioning members is located on the locked position, the plurality of teeth is located on the stage and configured for positioning the cushion, and when the pair of positioning members is located on the unlock position, the plurality of teeth is deviated from the stage.

4. The mounting apparatus of claim 3, wherein the positioning module further comprises a vacuum device configured to draw air between the cushions and the stage to prevent the cushions from warping.

5. The mounting apparatus of claim 1, wherein the fetching module is moveable along a first direction that is substantially parallel to a platform, the mounting module is movable along the first direction, and the positioning module is moveable along a second direction that is substantially perpendicular to the first direction.

6. The mounting apparatus of claim 1, wherein the fetching module comprises a fetching member configured for fetching the cushion to the stage , a discarding member configured to remove the cushion from the stage , and a connecting member, and the connecting member is coupled to the fetching member and the discarding member.

7. The mounting apparatus of claim 1, wherein the mounting module further comprises a storage member located on the platform, and the storage member is configured for storing the cushion from the stage.

8. The mounting apparatus of claim 1, wherein the receiving module comprises a receiving shelf and a pushing member attached to the receiving shelf, the receiving shelf is configured to receive the cushion, and the pushing member is configured to move the receiving shelf.

9. The mounting apparatus of claim 1, wherein the mounting module comprises a mounting member configured to mount the components to the device, the mounting member comprises a mounting clamp, a connecting portion, and an up-down guiding rail, a first end of the connecting portion is coupled to the mounting clamp, and a second end of the connecting portion is slidably attached to the up-down guiding rail.

10. The mounting apparatus of claim 9, wherein the mounting member further comprises an up-down motor, the up-down motor is coupled to the connecting portion, so that the connecting portion is movable upward or downward by the up-down motor.

11. A mounting apparatus configured for securing a component in a cushion to a device, the mounting apparatus comprising:
a receiving module configured for receiving the cushion;
a fetching module;
a control module; the fetching module is moveable along a first direction that is substantially parallel to a platform by the control module to catch the cushion from the receiving module;
a positioning module comprising a stage and a pair of positioning members deviated from the stage and configured for the cushion being located between the pair of positioning members and the stage; the pair of positioning members is moveable in the first direction by the control module in a direction close each other to position the cushion; and
a mounting module moveable by the control module to secure the cushion on the stage to the device.

12. The mounting apparatus of claim 11, wherein when the pair of positioning members is deviated from the stage, a first vertical distance, less than a thickness of the cushion, is defined between the stage and each positioning member, for preventing the cushions from stretching between the stage and the pair of the positioning members; when the pair of positioning members is located on the stage, a second vertical distance, greater than the thickness of the cushion, is defined between the stage and each positioning member, for allowing the cushions from stretching between the stage and the pair of the positioning members.

13. The mounting apparatus of claim 11, wherein a plurality of teeth is located on each of the pair of positioning members to position the cushion.

14. The mounting apparatus of claim 13, wherein the positioning module further comprises a vacuum device configured to draw air between the cushions and the stage to prevent the cushions from warping.

15. The mounting apparatus of claim 11, wherein the fetching module is moveable along a first direction that is substantially parallel to a platform, the mounting module is movable along the first direction, and the positioning module is moveable along a second direction that is substantially perpendicular to the first direction.

16. The mounting apparatus of claim 11, wherein the fetching module comprises a fetching member configured for fetching the cushion to the stage, a discarding member configured to remove the cushion from the stage, and a connecting member, and the connecting member is coupled to the fetching member and the discarding member.

17. The mounting apparatus of claim 11, wherein the mounting module further comprises a storage member located on the platform, and the storage member is configured for storing the cushion from the stage.

18. The mounting apparatus of claim 11, wherein the receiving module comprises a receiving shelf and a pushing member attached to the receiving shelf, the receiving shelf is configured to receive the cushion, and the pushing member is configured to move the receiving shelf.

19. The mounting apparatus of claim 11, wherein the mounting module comprises a mounting member configured to mount the components to the device, the mounting member comprises a mounting clamp, a connecting portion, and an up-down guiding rail, a first end of the connecting portion is coupled to the mounting clamp, and a second end of the connecting portion is slidably attached to the up-down guiding rail.

20. The mounting apparatus of claim 19, wherein the mounting member further comprises an up-down motor, the up-down motor is coupled to the connecting portion, so that the connecting portion is movable upward or downward by the up-down motor.
